(19) United States
(12) Patent Application Publication
(10) Pub. No.: US 2016/0252095 A1
(43) Pub. Date: Sep. 1, 2016

(54) AXIAL COMPRESSOR WITH A MAGNETIC STEPPER OR SERVO MOTOR

(71) Applicant: BORGWARNER INC., Auburn Hills, MI (US)

(72) Inventors: Sanjit CHAGGAR, Bradford, West Yorkshire (GB); Malcolm CARR, Mexborough (GB); Steve BIRNIE, Well Head, Halifax (GB); Adam SAMUELS, Manchester (GB); Hussam ZAMEL, Leeds (GB)

(21) Appl. No.: 15/030,075

(22) PCT Filed: Oct. 21, 2014
(86) PCT No.: PCT/US2014/061446

§ 371 Date: Apr. 18, 2016

Related U.S. Application Data
(60) Provisional application No. 61/894,955, filed on Oct. 24, 2013.

(51) Int. Cl. F04D 17/02; F04D 29/54; F04D 29/32; F04D 29/053; F04D 29/28; F04D 29/059; F02B 33/40; F02B 37/04; F02B 39/10; F04D 29/42; F04D 25/06; F01D 5/02

(52) U.S. Cl. CPC F04D 17/025; F04D 25/06; F04D 29/545; F04D 29/321; F04D 29/325; F04D 29/053; F01D 5/02; F04D 29/059; F02B 33/40; F02B 37/04; F02B 39/10; F04D 29/4206; F04D 29/284; F05D 2220/40; F05D 2240/60

(57) ABSTRACT

An axial compressor (30) is disposed upstream from a compressor wheel (16), and may be mounted in the inlet pipe (32) of a compressor housing (26) of a turbocharger (10). The axial compressor (30) can increase the pressure ratio approximately 1.3. The axial compressor (30) can be driven by a motor (40), such as a magnetic stepper, servo and squirrel cage motor. The axial compressor may have a fan (34) where boost can be controlled by speed of the fan (34), which can be accelerated or decelerated depending on use conditions. A magnetic stepper motor (40) can drive the fan (34) with a fan wheel (36) having magnets (44) associated with energizeable coils (42) that make a rotating magnetic field that the magnets (44) can follow.

### CROSS-REFERENCE TO RELATED APPLICATION

This application claims priority to and all benefits of U.S. Provisional Application No. 61/894,955, filed on Oct. 24, 2013, and entitled “Axial Compressor With A Magnetic Stepper Or Servo Motor”.

### BACKGROUND

1. Field of the Disclosure

This disclosure relates to a turbocharger with an axial compressor driven by a motor. More particularly, this disclosure relates to an axial compressor to increase pressure ratio upstream from the compressor wheel of the turbocharger.

2. Description of Related Art

Advantages of turbocharging include increased power output, lower fuel consumption, and reduced pollutant emissions and improved transient response. The turbocharging of engines is no longer primarily seen from a high-power performance perspective, but is rather viewed as a means of reducing fuel consumption and environmental pollution on account of lower carbon dioxide (CO₂) emissions. Currently, a primary reason for turbocharging is using exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber in a controlled manner. Consequently, more fuel can be burned, so that the engine's power output increases relative to the speed and swept volume.

In exhaust gas turbocharging, some of the exhaust gas energy, which would normally be wasted, is used to drive a turbine. The turbine includes a turbine wheel that is mounted on a shaft and is rotatably driven by exhaust gas flow. The turbocharger returns some of this normally wasted exhaust gas energy back into the engine, contributing to the engine's efficiency and saving fuel. A compressor, which is driven by the turbine, draws in filtered ambient air, compresses it, and then supplies it to the engine. The compressor includes a compressor wheel that is mounted on the same shaft so that rotation of the turbine wheel causes rotation of the compressor wheel.

Turbochargers typically include a turbine housing connected to the engine's exhaust manifold, a compressor housing connected to the engine's intake manifold, and a center bearing housing coupling the turbine and compressor housings together. The turbine housing defines a volute that surrounds the turbine wheel and that receives exhaust gas from the engine. The turbine wheel in the turbine housing is rotatably driven by a controlled inflow of exhaust gas supplied from the exhaust manifold.

This disclosure focuses on flow of air in the compressor stage, on the pressure ratio with respect to the compressor wheel, and on controlling boost.

### SUMMARY

This disclosure relates to placement of an axial compressor in series with the compressor section of an exhaust gas turbocharger. When placed in the air inlet of the compressor housing, the axial compressor can increase pressure ratio upstream from the compressor wheel, such as increasing the pressure ratio by approximately 1.3. The compressor wheel will then further compress the initially compressed air, whereby the compressor provides compressed air at a higher pressure than normal, e.g. than a turbocharger without the axial compressor. Thus, the combined increase of pressure of the system including the turbocharger compressor with an added axial compressor can increase the total pressure, thus higher density, as more air is supplied into a combustion chamber of an engine. The amount of boost provided by the system is directly controlled by the fan speed with maximum boost available when the engine and turbocharger accelerate. In possible stall situations, the fan direction can be reversed resulting in a lower pressure ratio.

An axial compressor can readily be fixed in the inlet pipe of the turbocharger compressor housing or the pipe connecting the compressor housing inlet to the air induction system of an engine, and can be associated with or integrated into a fan wheel. Minimum inertia is required to operate the axial compressor. There are no shaft or lubricant requirements for such an axial compressor. Thus, controllable thrust and increased pressure ratio can maximize efficiency and operation of the compressor stage.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a cross sectional view of a turbocharger showing the location of an axial compressor;

FIG. 2 is a partial bi-sectional cutaway of an axial compressor; and

FIG. 3 shows an example of energizeable coils and magnets that can produce a rotating fan.

### DETAILED DESCRIPTION

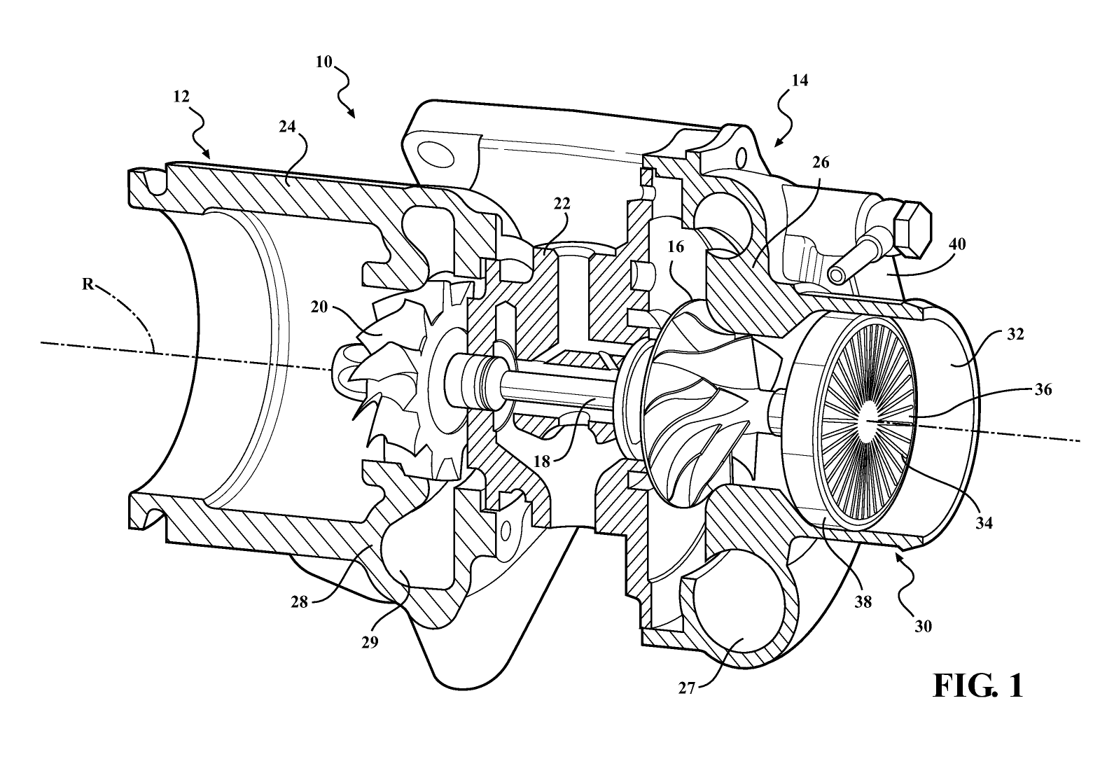

Referring to FIG. 1, the turbocharger 10 includes a turbine section 12, a compressor section 14, and a center bearing housing 22 disposed between and connecting the compressor section 14 to the turbine section 12. The turbine section 12 includes a turbine housing 28 that defines an exhaust gas inlet (not shown), an exhaust gas outlet 24, and a turbine volute 29 disposed in the fluid path between the exhaust gas inlet and exhaust gas outlet 24. A turbine wheel 20 is disposed in the turbine housing 28 between the turbine volute 29 and the exhaust gas outlet 24. A shaft 18 is connected to the turbine wheel 20, is rotatably supported within in the bearing housing 22, and extends into the compressor section 14. The compressor section 14 includes a compressor housing 26 that defines an air inlet 32, an air outlet (not shown), and a compressor volute 27. The compressor air inlet 32 is a hollow, cylindrical member that extends coaxially with the rotational axis R of the shaft 18. A radial-flow compressor wheel 16 is disposed in the compressor housing 26 between the air inlet 32 and the compressor volute 27. The compressor wheel 16 is connected to, and driven by, the shaft 18.

In use, the turbine wheel 20 is rotatably driven by an inflow of exhaust gas supplied from an engine. Since the drive shaft 18 connects the turbine wheel 20 to the compressor wheel 16, the rotation of the turbine wheel 20 causes rotation of the compressor wheel 16. As the compressor wheel 16 rotates, it increases the air mass flow rate, airflow density and air pressure delivered to the engine's cylinders via an outflow from the compressor air outlet, which is connected to the engine's air intake manifold.

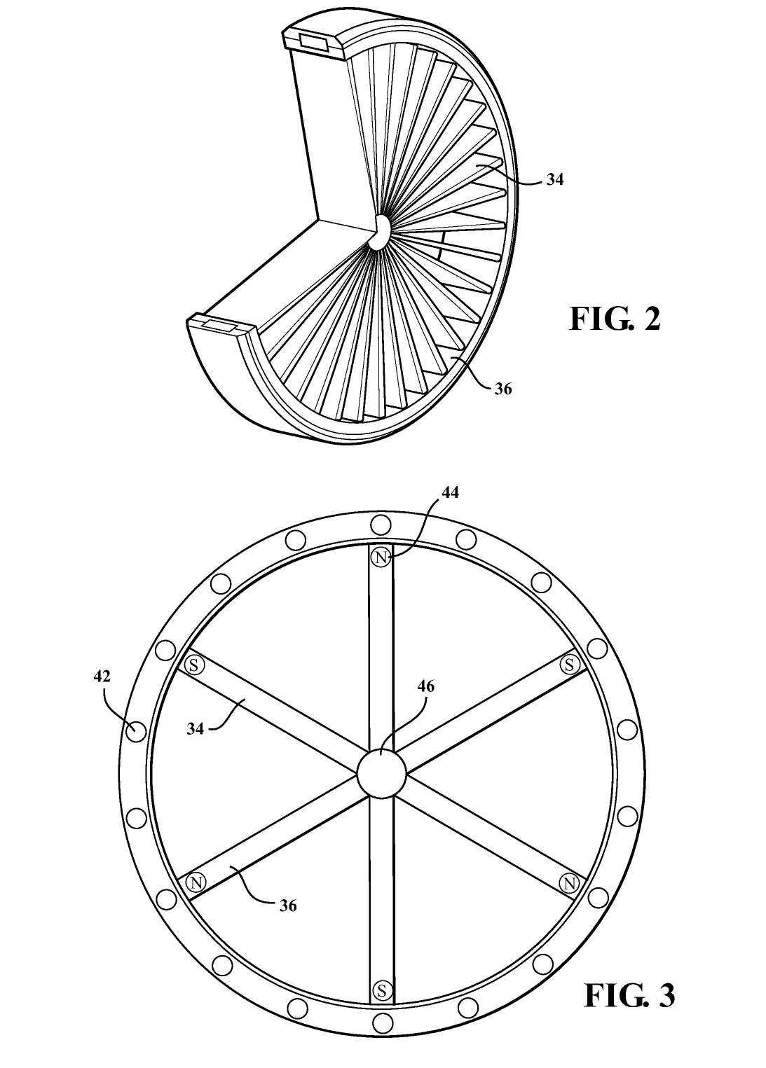

Referring also to FIG. 2, the turbocharger 10 is provided with an axial compressor 30 disposed in the inlet pipe 32 of the compressor housing 26. The axial compressor 30 is a compressor in which the gas or working fluid principally flows parallel to the axis of rotation. Such compressors produce a continuous flow of compressed gas, and have the benefits of high efficiency and large mass flow rate, particularly in relation to their size and cross-section. In the illustrated embodiment, the axial compressor 30 is a fan 34 with an axial flow fan wheel 36. The axial compressor 30 can be supported by rolling element bearings 38 at the periphery of the axial compressor 30. The fan wheel 36 can be driven so that it rapidly accelerates or decelerates depending on driving conditions. A motor controller can control the acceleration or deceleration to optimize the compressor map of the turbocharger 10.

The axial compressor 30 is ideally made of plastic. Plastics can be molded into the desired shape. Such polymers are lightweight, durable and flexible, while not requiring lubrication. Other beneficial characteristics include that axial compressors 30 made of plastic are inexpensive and slow to degrade.

Due to its location in the compressor inlet pipe 32, the axial compressor 30 increases the pressure ratio upstream from the compressor wheel 16 in the compressor housing 26. The turbocharger 10 and its components do not require substantial changes for adding an axial compressor 30, but a longer inlet pipe 32 without obstruction is typically desired. Other equivalent pipes include a pipe connecting the compressor housing inlet to the air induction system of an engine.

The axial compressor 30 can increase pressure ratio upstream from the compressor wheel 16. As an example, the axial compressor 30 can increase the pressure ratio by approximately 1.3 with respect to the compressor wheel 16. Following compression of the air in the axial compressor 30, the compressor wheel 16 will then further compress the initially compressed air. As a result, the pressure ratio of air exiting the compressor 14 is increased relative to air exiting a compressor without the axial compressor 30. Thus, the combined increase of pressure with an added axial compressor 30 can increase the pressure, thus providing higher density air, as more air is supplied into a combustion chamber of an engine.

The axial compressor 30 can be driven by various motors 40, such as all types of stepper motor, an a.c. servo motor, d.c servo motor, other types of DC motors, a.c. induction motor or any other types of motor. FIG. 3 illustrates a magnetic stepper motor including energizeable coils (42) configured to provide a rotating magnetic field. The magnetic stepper motor is configured to drive the fan (34) via cooperation of the magnets (44) with the energizeable coils (42). For example, the magnetic stepper motor 40 rotates in short, uniform movements, with the example step of 60 degrees (but the step can readily be 30, 45 or 90 degrees). The speeds can be in the range of zero to 70 krpm in clockwise or counterclockwise direction as an example. As shown in FIG. 3, coils 42 can be energized in turn to create a rotating magnetic field. The magnets 44 in the fan wheel 36 follow the rotating field. In the exemplary embodiment, the magnets 44 are incorporated into the distal end of respective wheel spokes, and have alternating polarity. Additional blades of the fan wheel 36 can be between wheel spokes with magnets 44. For illustrative purposes, a center bearing 46 is shown in FIG. 3.

The speed of rotation is controlled by the speed that the coils 42 are switched on and off. The direction is controlled by the order that the coils 42 are energized.

The fan wheel speed directly controls the amount of boost provided by the turbocharger 10. The fan speed can be controlled by a stepper motor controller to give optimum boost.

An example includes maximum boost required when a vehicle goes uphill, and the axial compressor 30 would run at the maximum speed. When going downhill in a possible stall condition, the fan 34 can be reversed resulting in reduced pressure of less than 1.0.

In a pre-start condition, the engine is stationary, and the turbocharger 10 is stationary with the axial compressor 30 stationary. At engine start or idle, a battery drives the axial compressor 30 at low speed while the turbocharger 10 is driven at low speed. As the engine accelerates, the axial compressor 30 can be driven to maximize boost while the turbocharger 10 accelerates through increased exhaust. As the engine decelerates, the drive of the axial compressor 30 is removed, the engine speed decreases and the turbocharger speed decreases due to low exhaust. Thus, the axial compressor 30 can be rapidly accelerated or decelerated based on driving and engine conditions.

The axial compressor 30 can also be driven by an AC motor in conjunction with an inverter. A squirrel cage motor can be used with the inverter to control the fan 34. While this option may be lower cost, the motor is less responsive than a magnetic stepper or servo motor.

The invention has been described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed is:

1. A turbocharger (10) comprising
a turbine section (12) including a turbine wheel (20),
a compressor section (14) including compressor housing (26) and a compressor wheel (16) disposed in the compressor housing (26),
a shaft (18) connecting the turbine wheel (20) to the compressor wheel (16),
an axial compressor (30) configured to increase a pressure ratio upstream from the compressor wheel (16).

2. The turbocharger (10) of claim 1, wherein the axial compressor includes an axial flow fan (34) arranged in series with the compressor wheel (16).

3. The turbocharger (10) of claim 1 wherein the axial compressor (30) includes a fan (34) with a fan wheel (36), and a boost provided by the turbocharger (10) is controlled by speed of the fan (34).

4. The turbocharger (10) of claim 1 wherein the axial compressor (30) increases the pressure ratio approximately 1.3 with respect to the compressor wheel (16).

5. The turbocharger (10) of claim 1 wherein the axial compressor (30) is supported by rolling element bearings (38) at its periphery.

6. The turbocharger (10) of claim 1 wherein the axial compressor (30) is driven by a magnetic stepper motor (40).

7. The turbocharger (10) of claim 6 wherein the axial compressor (30) includes a fan (34) with a fan wheel (36) having magnets (44) associated with energizeable coils (42) that make a rotating magnetic field that the magnets (44) can follow.

8. The turbocharger (10) of claim 1 wherein the axial compressor (30) is driven by a servo motor (40).

9. The turbocharger (10) of claim 1 wherein the axial compressor (30) is driven by an AC motor in conjunction with an inverter.

10. The turbocharger (10) of claim 1 wherein the axial compressor (30) is mounted in an elongated inlet pipe (32) of the compressor housing (26).

11. A turbocharger (10) comprising
a compressor (14) including
a compressor housing (26) that defines an inlet pipe (32), and
a compressor wheel (16) disposed the compressor housing (26); and
an axial compressor (30) mounted in the inlet pipe (32), the axial compressor including a fan (34) wherein boost of the turbocharger (10) can be controlled by speed of the fan (34), the fan (34) including a fan wheel (36) having magnets (44); and
a magnetic stepper motor (40) including energizeable coils (42) configured to provide a rotating magnetic field, the magnetic stepper motor configured to drive the fan (34) via cooperation of the magnets (44) with energizeable coils (42),
wherein the axial compressor (30) increases the pressure ratio approximately by 1.3 upstream of the compressor wheel (16).

12. The turbocharger (10) of claim 11 wherein the speed of the fan (34) ranges from zero to 70 krpm in a clockwise or counterclockwise direction.
